(19) United States
(12) Patent Application Publication
(10) Pub. No.: US 2025/0268161 A1
(43) Pub. Date: Aug. 28, 2025

(54) HYDROPONICS SYSTEM

(71) Applicant: Adrian J. Aguilera, Covina, CA (US)

(72) Inventor: Adrian J. Aguilera, Covina, CA (US)

(21) Appl. No.: 18/974,711

(22) Filed: Dec. 9, 2024

Related U.S. Application Data
(60) Provisional application No. 63/608,800, filed on Dec. 11, 2023.

(51) Int. Cl. A01G 31/06

(52) U.S. Cl. CPC A01G 31/06

(57) ABSTRACT

A hydroponics system is made up of one or more hydroponic stacks. Each hydroponic stack has a first horizontally extending trough and a second horizontally extending trough, each trough having an interior channel that extends from an inlet to an outlet. A supporting structure supports the first trough and the second trough so that the troughs are vertically spaced from one another. A flow connector connects the outlet of the first trough to the inlet of the second trough. The troughs contain a plurality of plants, and a nutrient solution is introduced into the inlet of the first trough and flows through the interior channel of the first trough to the outlet of the first trough, through the flow connector to the inlet of the second trough, and through the interior channel of the second trough to the outlet of the second trough. In one version, a plurality of hydroponic stacks are moveable relative to one another.

### PRIORITY

The present application claims the benefit of domestic priority based on U.S. Provisional Patent Application 63/608,800 filed on Dec. 11, 2023, the entirety of which is incorporated herein by reference.

### BACKGROUND

With the recent advent of climate change, labor shortages, and food production preferences, agricultural technology is taking on ever increasing importance. In a field plagued by volatility, improvements in the way we farm is needed to help increase yields, efficiency, profitability, and/or produce healthier crops.

One technology that has been developing to help improve agricultural processes is hydroponics. Hydroponics is a technique where a water-based nutrient solution is used in place of soil to nourish plants. The roots of the plants may be directly exposed to the solution and/or may be supported by an inert medium, such as perlite, vermiculite, gravel, rock wool, clay, growstones, coconut coir, rice husks, pumice, wood fiber, sheep's wool, brick shards, polystyrene, and the like. Hydroponics offers many advantages, such as decreased water usage and the ability to grow crops in climates and/or locations where the crops would otherwise be difficult to grow.

However, conventional hydroponics techniques suffer from many disadvantages. For example, conventional hydroponics systems are designed for a specific kind of crop and therefore lack plant flexibility. The production areas do not allow for easy expansion or reduction in size or capacity. The conventional systems are often fixed in place and have large areas of non-productive space. In addition, conventional hydroponic systems require a large amount of human labor to plant, maintain, and harvest the crops.

There is therefore a need for an improved hydroponics system. There is further a need for an improved hydroponics system that provides flexibility in terms of the type of crops and/or the amount of crops grown. There is further a need for an improved hydroponics system that increases the efficiency of the use of space used for growing the crops. There is further a need for an improved hydroponics system that reduces the amount of labor needed to operate the system.

### SUMMARY

The present invention satisfies these needs. In one aspect of the invention, an improved hydroponics system is provided.

In another aspect of the invention, a hydroponics system is provided that increases the flexibility of types and/or quantity of plants or crops that are produced.

In another aspect of the invention, a hydroponics system is provided that increases the efficiencies of the use of space for growing crops or plants.

In another aspect of the invention, a hydroponics system is provided that decrease the amount of human labor needed to operate the system.

In another aspect of the invention, a hydroponics system is provided that is efficient, streamlined, and/or convenient to use.

In another aspect of the invention, a hydroponics system is made up of a stack of hydroponic rows.

In another aspect of the invention, a hydroponics system is made up of a stack of hydroponic rows, wherein the stack is moveable.

In another aspect of the invention, a hydroponics system is made up of a stack of hydroponic rows, wherein nutrient solution flows from one hydroponic row to another hydroponic row in the stack.

In another aspect of the invention, a hydroponics system is made up of a stack of hydroponic rows, the rows being in vertical and/or horizontal pairs.

In another aspect of the invention, a hydroponics system is made up of a stack of hydroponic rows, wherein a control system controls operation of the hydroponics system.

In another aspect of the invention, a hydroponics system is made up of a stack of hydroponics rows that share a flow of nutrient solution.

In another aspect of the invention, a hydroponics system is made up of a plurality of stacks of hydroponics rows that share a flow of nutrient solution.

In another aspect of the invention, a hydroponics system is made up of a plurality of stacks of hydroponics rows that share a flow of nutrient solution, wherein each stack is moveable relative to the other stacks.

In another aspect of the invention, a hydroponics system is made up of a plurality of stacks of hydroponics rows that share a flow of nutrient solution, wherein each stack is moveable relative to the other stacks to create an operational area.

In another aspect of the invention, a hydroponics system is made up of a plurality of stacks of hydroponics rows that share a flow of nutrient solution, wherein each stack is moveable relative to the other stacks to create an operational area where a robotics system can operate.

In another aspect of the invention, an improved method of growing plants in a hydroponics system is provided.

In another aspect of the invention, a method of growing plants comprises providing a hydroponics system as described herein and using the hydroponics system as described herein.

In another aspect of the invention, a hydroponics system comprises one or more hydroponic stacks, each hydroponic stack comprising a first trough, the first trough comprising a horizontally extending trough body, the trough body comprising walls that define an interior channel that extends from an inlet at an inlet end of the first trough to an outlet at an outlet end of the trough, a second trough, the second trough comprising a horizontally extending trough body, the trough body comprising walls that define an interior channel that extends from an inlet at an inlet end of the first trough to an outlet at an outlet end of the trough, a supporting structure that supports the first trough and the second trough, wherein the first trough and second trough are vertically spaced from one another and vertically aligned with one another, and a flow connector that connects the outlet of the first trough to the inlet of the second trough, wherein the first trough is adapted to contain a plurality of plants in an arrangement so that each plant in the first trough is in fluid communication with the interior channel of the first trough, wherein the second trough is adapted to contain a plurality of plants in an arrangement so that each plant in the second trough is in fluid communication with the interior channel of the second trough, and wherein a nutrient solution can be introduced into the inlet of the first trough so that the nutrient solution can flow through the interior channel of the first trough to the outlet of the first trough, through the flow connector to the inlet of the second trough, and through the interior channel of the second trough to the outlet of the second trough.

In another aspect of the invention, a hydroponics system comprises one or more hydroponic stacks, each hydroponic stack comprising a first trough, the first trough comprising a horizontally extending trough body, the trough body comprising walls that define an interior channel that extends from an inlet at an inlet end of the first trough to an outlet at an outlet end of the trough, a second trough, the second trough comprising a horizontally extending trough body, the trough body comprising walls that define an interior channel that extends from an inlet at an inlet end of the first trough to an outlet at an outlet end of the trough, a supporting structure that supports the first trough and the second trough, wherein the first trough and second trough are vertically spaced from one another and vertically aligned with one another, and a flow connector that connects the outlet of the first trough to the inlet of the second trough, wherein the first trough is adapted to contain a plurality of plants in an arrangement so that each plant in the first trough is in fluid communication with the interior channel of the first trough, wherein the second trough is adapted to contain a plurality of plants in an arrangement so that each plant in the second trough is in fluid communication with the interior channel of the second trough, wherein a nutrient solution can be introduced into the inlet of the first trough so that the nutrient solution can flow through the interior channel of the first trough to the outlet of the first trough, through the flow connector to the inlet of the second trough, and through the interior channel of the second trough to the outlet of the second trough, and wherein the first trough and the second trough make up a first pair of troughs of the hydroponic stack, wherein the hydroponic stack further comprises a second pair of first and second troughs, and wherein the second pair of troughs is vertically spaced and vertically aligned with the first pair of troughs.

In another aspect of the invention, a hydroponics system comprises a first hydroponic stack, the first hydroponic stack comprising: a plurality of horizontally extending and vertically spaced troughs, each trough comprising an interior channel adapted to contain a plurality of plants, and a first supporting structure that supports the plurality of vertically spaced troughs of the first hydroponic stack; and a second hydroponic stack, the second hydroponic stack comprising: a plurality of horizontally extending and vertically spaced troughs, each trough comprising an interior channel adapted to contain a plurality of plants, and a second supporting structure that supports the plurality of vertically spaced troughs of the second hydroponic stack, wherein the second supporting structure is moveable relative to the first supporting structure so that the second hydronic stack can be moved towards or away from the first hydroponic stack, and wherein a nutrient solution can flow through each of the interior channels to provide nutrients to the plants.

In another aspect of the invention, a hydroponics system comprises a first hydroponic stack, the first hydroponic stack comprising: a plurality of horizontally extending and vertically spaced troughs, each trough comprising an interior channel adapted to contain a plurality of plants, and a first supporting structure that supports the plurality of vertically spaced troughs of the first hydroponic stack; and a second hydroponic stack, the second hydroponic stack comprising: a plurality of horizontally extending and vertically spaced troughs, each trough comprising an interior channel adapted to contain a plurality of plants, and a second supporting structure that supports the plurality of vertically spaced troughs of the second hydroponic stack, wherein the second supporting structure is moveable relative to the first supporting structure so that the second hydronic stack can be moved towards or away from the first hydroponic stack, wherein a nutrient solution can flow through each of the interior channels to provide nutrients to the plants, wherein the second supporting structure comprises one or more vertical support members suspended from a top support, and wherein the top support comprises a moveable suspension mechanism that allows the second hydroponic stack to be moved sufficiently far away from the first hydroponic stack to create an operational area between the first hydroponic stack and the second hydroponic stack, and wherein the hydroponics system further comprises a robotic system that is selectively positionable within the operational area.

In another aspect of the invention, a method of growing plants in a hydroponics system, the method comprises providing a hydroponics system comprising a first hydroponic stack comprising a plurality of rows of plants; a second hydroponic stack comprising a plurality of rows of plants; and a third hydroponic stack comprising a plurality of rows of plants; moving the third hydroponic stack away from the second hydroponic stack to create an operational area between the second hydroponic stack and the third hydroponic stack; accessing the operational area between the second hydroponic stack and the third hydroponic stack to operate on the third hydroponic stack and/or the second hydroponic stack; moving the second hydroponic stack toward the third hydroponic stack to reduce the operational area between the second hydroponic stack and the third hydroponic stack and to create an operational area between the first hydroponic stack and the second hydroponic stack; and accessing the operational area between the first hydroponic stack and the second hydroponic stack to operate on the second hydroponic stack and/or the first hydroponic stack.

### BRIEF DESCRIPTION OF THE DRAWINGS

These features, aspects, and advantages of the present invention will become better understood with regard to the following description, appended claims, and accompanying drawings which illustrate exemplary features of the invention. However, it is to be understood that each of the features can be used in the invention in general, not merely in the context of the particular drawings, and the invention includes any combination of these features, where:

FIG. 1A is a schematic front view of a hydroponics system according to one version of the invention;

FIG. 1B is a schematic sectional view at 1B-1B in FIG. 1A;

FIG. 2 is a schematic front view of another version of a hydroponics system of the invention;

FIG. 3 is a schematic front view of another version of a hydroponics system of the invention;

FIG. 4 is a schematic front view of another version of a hydroponics system of the invention;

FIG. 5A is a schematic partial front view of another version of a hydroponics system of the invention;

FIG. 5B is a schematic side view of a section at 5B-5B of FIG. 5A;

FIG. 6 is a schematic side view of another hydroponics system of the invention viewing from a position similar to FIG. 5B;

FIG. 7A is a schematic partially sectional view of an inlet end of a horizontal pair of troughs of a version of a hydroponics system of the invention;

FIG. 7B is a schematic partially sectional view of an inlet end of a horizontal pair of troughs of another version of a hydroponics system of the invention;

FIG. 8 is a schematic partially sectional side view of another version of a hydroponics system of the invention;

FIG. 9A is a schematic partially sectional side view of another version of a hydroponics system of the invention;

FIG. 9B is a schematic partially sectional side view of the version of a hydroponics system of FIG. 9A with one a hydroponic stack moved;

FIG. 10A is a schematic side view of a version of a hydroponics system of the invention;

FIG. 10B is a front, side perspective view of the hydroponics system of FIG. 10A;

FIG. 10C is a front, side, top perspective view of the hydroponics system of FIG. 10A;

FIG. 11A is a schematic front, side perspective view of a robotic system that may be used with the hydroponics system of the invention;

FIG. 11B is a schematic side perspective view of the robotic system of FIG. 11A is operation;

FIG. 12 is a schematic top, side perspective view of a plant pod system that may be used in the hydroponics system of the invention;

FIG. 13A is a schematic side perspective view from below of a version of a moveable suspension mechanism of a version of the hydroponics system of the invention;

FIG. 13B is a schematic front view of the hydroponics system of FIG. 13A;

FIG. 14A is a schematic side perspective view from below of a version of a moveable suspension mechanism of a version of the hydroponics system of the invention;

FIG. 14B is a schematic front view of the hydroponics system of FIG. 14A;

FIG. 15 is a schematic front, side, top perspective view of a version of a hydroponic stack of the hydroponic system of the invention; and

FIG. 16 is a schematic front, side, top perspective view of another version of a hydroponics system of the invention.

### DESCRIPTION

The present invention relates to agricultural technology. In particular, the invention relates to an improved hydroponics system. Although the hydroponics system is illustrated and described in the context of being useful for growing one or more plants, the present invention can be useful in other instances. Accordingly, the present invention is not intended to be limited to the examples and embodiments described herein.

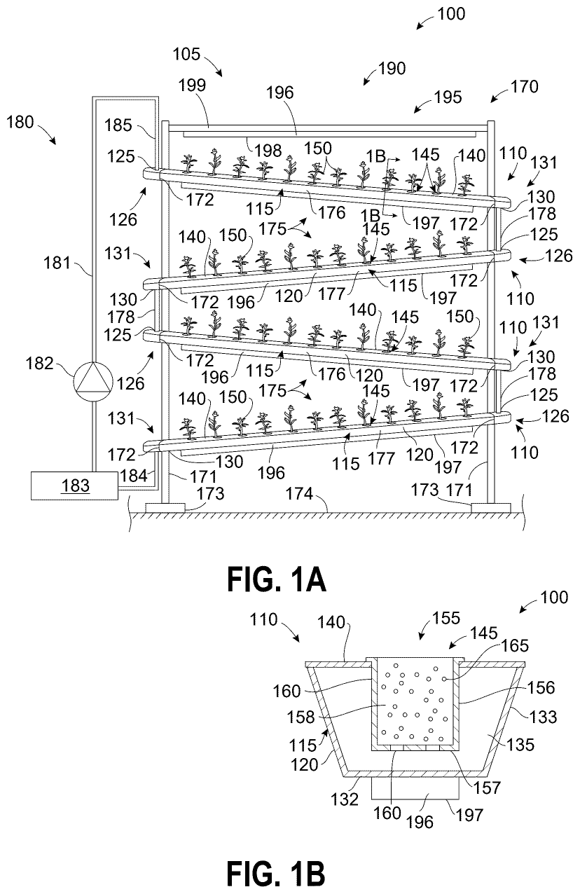

FIG. 1A shows a version of a hydroponics system 100 according to the invention. The hydroponic system 100 includes a hydroponic stack 105 comprising a plurality of hydroponic rows 110. Each hydroponic row 110 is made up of a trough 115 having a trough body 120. The trough body 120 has an inlet 125 at a first end or inlet end 126 of the trough body 120 and an outlet 130 at a second end or outlet end 131 of the trough body 120. The trough body 120 include walls, such as an elongated bottom 132 and side walls 133, that together define an interior channel 135, as seen in FIG. 1B, that extends horizontally from the inlet 125 to the outlet 130. By extend horizontally, it is meant that the inlet 125 and the outlet 130 are spaced from one another in the horizontal direction, and the interior channel 135 extends at least partially in a horizontal plane or at least partially at an angle less than 45 degrees with respect to a horizontal plane, as will be discussed. The interior channel 135 extends from the first end 126 of the trough 115 to the second end 131 of the trough 115. A top member 140 is optionally provided to at least partially cover the interior channel 135. The top member 140 includes one of more openings 145 extending therethrough that are adapted to receive a plant 150 either directly or in a plant container 155. Alternatively, the trough 115 can have an open top and the plant 150 and/or plant container 155 can be placed directly into the interior channel 135.

The plant container 155 is positioned within the interior channel 135 so that it is in contact with a nutrient solution that flows through the interior channel 135. The plant container 155 includes sidewalls 156 and a bottom 157 that define an interior cavity 158. The sidewalls 156 and/or bottom 157 can be provided with one or more openings 160 that allow for the passage of the nutrient solution into the interior cavity 158 of the plant container 155. The openings 160 can be in the form of holes, slits, pores, and/or the like. The plant 150 is positionable within the interior cavity 158 of the plant container 155 so that the roots of the plant 150 are able to be exposed to the nutrient solution. Optionally, the interior cavity 158 of the plant container 155 contains a medium 165, such as one or more of rock wool, perlite, vermiculite, gravel, clay, growstones, coconut coir, rice husks, pumice, wood fiber, sheep's wool, brick shards, polystyrene, and the like. The medium is typically inert and serves to provide structural support for the roots and the plant 150 while allowing the nutrient solution to provide water and nutrients to the plant 150 and some may be reused from one planting to the next. The nutrient solution is a water based solution that contains dissolved nutrients in a form and concentration selected so that the nutrients can be taken up by the plant as the plant grows and develops. The nutrient solution may also contain fertilizer. The nutrient solution can be a general purpose solution or can be one specifically designed for a particular plant type. The nutrient solution can be made, for example, from synthetic solutions which are made with chemical fertilizers or from organic solutions which are made with natural ingredients such as fish emulsion, kelp meal, and compost tea.

The nutrient solution is introduced into the interior channel 135 of the trough 115 through the inlet 125. The nutrient solution flows through the interior channel 135 where it comes in contact with any plant roots in the interior channel 135 and then exits the interior channel 135 through the outlet 130. The trough 115 can be positioned horizontally, or as shown to an exaggerated extent in the version of FIG. 1A, can be slanted to facilitate the flow through the interior channel 135. The angle of slant can range from about 0 degrees to about 10 degrees, and in one particular version is about 2 degrees.

A supporting structure 170 can be provided to support the one or more troughs 115 of the hydroponics system 100. In the version of FIG. 1A, the supporting structure 170 includes one or more vertical support members 171 and a trough supporting member 172 that is adapted to support at least a portion of the trough 115 on a vertical support member 171. The trough supporting member 172 can be, for example, a strap or band that surrounds at least a portion of the trough 115 and connects it to the vertical support member 171 or can be a bar or hook that is connected to the vertical support member 171 and that supports the trough 115 by its own weight, or any other supporting and/or connecting mechanism. In one version, the trough supporting member 172 is adjustable along the vertical support member 171 so as to allow for the adjustment of the height and/or positioning of the trough 115 being supported in accordance with the plant being grown in the tough 115. For example, a Unistrut track can be provided for the adjustment. The Unistrut tract can also allow the hydroponic stack 105 to be condensed when not in use and allows the density of the plants grown in a given area to be increased. In one version, the trough supporting member 172 is adjustable so that the angle of slant of the trough 115 can be selected or adjusted. In the particular version shown, the vertical support members 171 include a stand 173 for positioning the supporting structure 170 on the floor 174 or ground or other structure.

As can be seen in FIG. 1A, in one version, the hydroponic stack 105 of the hydroponics system 100 includes a pair of vertically spaced pair 175 of troughs 115 made up of a first trough 176 that is elevated vertically relative to a second trough 177. In addition to being vertically spaced relative to one another, the first trough 176 and the second trough 177 are rotated, such as by being rotated 180 degrees relative to one another about a vertical axis, so that the first or inlet end 126 of the second trough 177 is positioned substantially beneath or in proximity to the second or outlet end 131 of the first trough 176. This positioning and orientation allows the nutrient solution flowing out of the outlet 130 of the first trough 176 to flow into the inlet 125 of the second trough 177 of the vertical pair 175. This cascading action allows the vertical pair 175 of troughs 115 to utilize the same nutrient solution. An outlet to inlet fluid flow connector 178, such as a pipe, tube, or hose, can be provided to facilitate the flow from one trough 115 to another.

Alternatively, the respective outlet 130 and inlet 125 can be positioned in close enough proximity to one another and/or are adjoined to one another so that the flow passes directly from one an outlet 130 in the first trough 176 to an inlet 125 in the second trough 177. In addition to being vertically spaced, the pair of vertically spaced troughs 175 can be vertically aligned so that at least a portion of the first trough 176 and the second trough 177 lie in the same vertical plane. This allows the flow from an outlet 130 of the first trough 176 to an inlet 125 of the second trough 177 to be smooth and efficient. A series of vertically spaced pairs 175 can be positioned below one another as shown in FIG. 1A. In this arrangement, the bottommost outlet 130 is positioned on the same side of the hydroponic stack 105 as the topmost inlet 125. Alternatively, the bottommost trough 115 can be only the top half of a vertically spaced pair 175 so that the bottommost outlet 130 is positioned on the opposite side of the hydroponic stack 105 as the topmost inlet 125. In another version, the first trough 176 and the second trough 177 can be rotated relative to one another by an angle other than 180 degrees, such as an angle of 90 degrees or 120 degrees, so that a square or triangular shaped arrangement or the like can be provided.

The hydroponics system 100 can also include a nutrient solution circulation system 180, as shown in FIG. 1A. A fluid line or tubing 181 is provided that receives nutrient solution flowing out of an outlet 130, such as the bottommost outlet 130 in the hydroponic stack 105, and returns the nutrient solution to an inlet 125, such as the topmost inlet 125 in the hydroponic stack 105. Alternatively, the fluid line or tubing 181 can deliver the nutrient solution to a different hydroponic stack 105. In the version of FIG. 1A where the nutrient solution is recirculated within the same hydroponic stack 105, a pump 182 can be provided to push the nutrient solution to the top of the hydroponic stack 105. Optionally, a reservoir 183 can be provided within the flow circuit. An outlet line 184 receives nutrient solution from the outlet 130 and delivers it to the reservoir 183, and an inlet line 185 delivers nutrient solution from the reservoir 183 to the inlet 125. The reservoir 183 can be used to monitor the condition, volume, and/or composition of the nutrient solution and adjustments can be made to the nutrient solution as needed.

The hydroponics system 100 can also include a lighting system 190 that is designed to provide light energy to the plants 185 being grown. In the version of FIG. 1A, the lighting system 190 includes a hydroponic stack lighting system 195 that is at least partially internal and/or connected to a hydroponic stack 105. In the particular version shown, the hydroponic stack lighting system 195 comprises a plurality of lights 196 that are each associated with a row 110 of the hydroponic stack 105. In the particular version shown, a trough light 197 is provided on the exterior of the bottom 132 of a trough 115 so that the light can be provided to the plants in a tough 115 directly below the trough light 197. The trough light 197 on the bottommost trough 115 in the hydroponic stack 105 can either be provided or removed. When provided, the trough light 197 can be switched off to conserve power or can be turned on if there is a need to light the area below the bottommost trough 105. A top light 198 can be additionally provided for the topmost row 110 in the hydroponic stack 105. The top light 198 can be positioned on a ceiling or other structure or a light support member 199 be provided on the supporting structure 170. The lights 196 can be fixed in position or can be mounted in a manner that allows the lights 196 to be extended or adjusted in position.

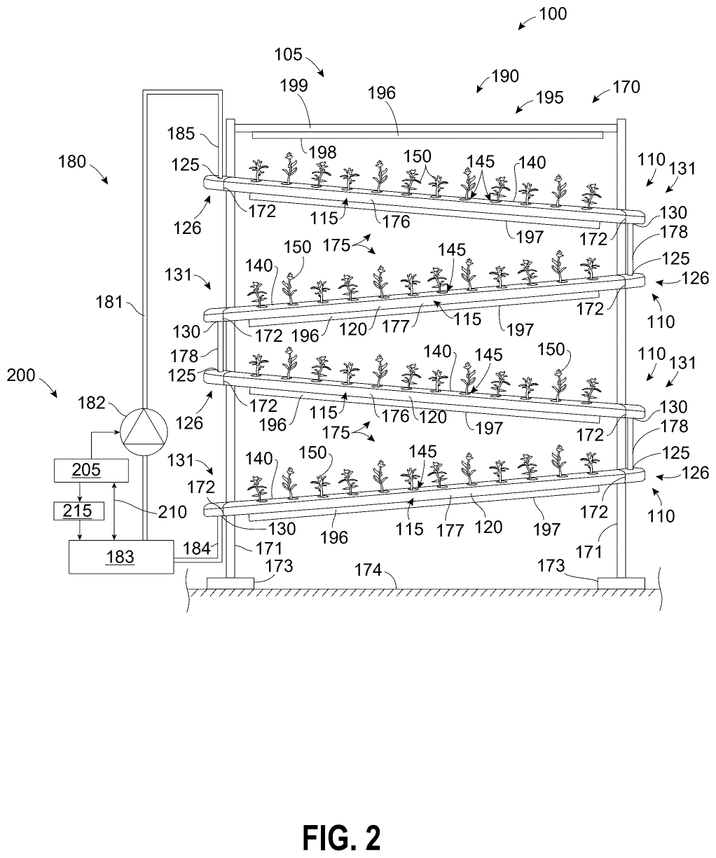

Another version of a hydroponics system 100 is shown in FIG. 2. The version of FIG. 2 is similar to the version of FIG. 1A, but in this version, a control system 200 is provided to control one or more parts of the operation of the hydroponics system 100. In the particular version shown, the control system 200 includes a controller 205 that controls operation of the circulation system 180. For example, the controller 205 can control the operation of the pump 182, such as by turning the pump 182 on or off or adjusting the speed of the pump 182. The controller 205 can also interact with the reservoir 183. For example, the controller 205 can receive input 210 from the reservoir 183 and produce output related to the data. In one version, the controller 205 receives information concerning the volume and/or composition of the nutrient solution. The controller 205 can then generate output related to the input 210. For example, the controller 205 can provide a display or other visual or audible signal related to the input so an operator can be alerted when an adjustment is needed. In one version, the controller 205 can make automatic adjustments based on the analyzed input 210. In the version shown, the controller 205 communicates with an adjustment module 215 and causes the adjustment module 215 to adjust the nutrient solution in the reservoir 183 as needed. The adjustment module can comprise a water source, a nutrient source, and/or the like.

The control system 200 can be any device capable of receiving input, performing calculations, performing calculations based on the input, producing an output signal, and/or producing an output signal as a result of the calculations. The controller 205 may be a single controller or multiple controllers that are capable of communication with one another. The controller 205 may be in the form of a central processor that is capable of interacting with a user via a keyboard, a graphical user interface, wireless communication, voice command, or any other manner. For example, the controller 205 may be a personal computer, a laptop, a handheld device, a server, a network of servers, a cloud network, or the like. The operator may interact with the controller 205 before, during, or after a hydroponics process. The controller 205 can include various modules that allow it to perform calculations, algorithms, routines, and/or subroutines to process information and/or make determinations. The controller 205 may further include other optional modules, such as artificial intelligence and/or machine learning modules that use algorithms to parse data, learn from the data, and then to make determinations and/or predictions based on what was learned.

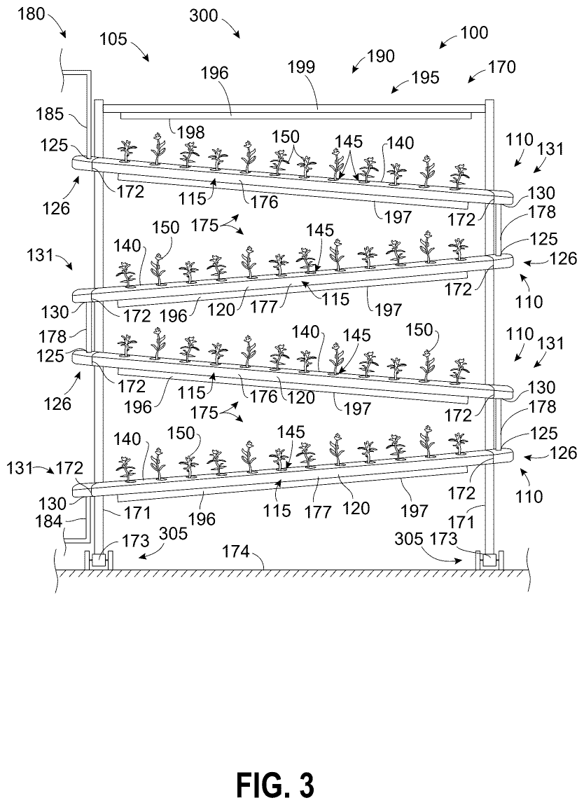

FIG. 3 shows another version of the hydroponics system 100 of the invention. In this version, the support structure 170 is a moveable support structure 300. In the version shown, the stand 173 of the support structure 170 is provided with one or more rollers 305, such as wheels, coasters, or the like. The moveable support structure 300 can be moved in one or more directions for added operational convenience before, during, and/or after hydroponic processing. The circulation system 180 can have sufficient slack or be otherwise designed to allow for a desired amount of movement.

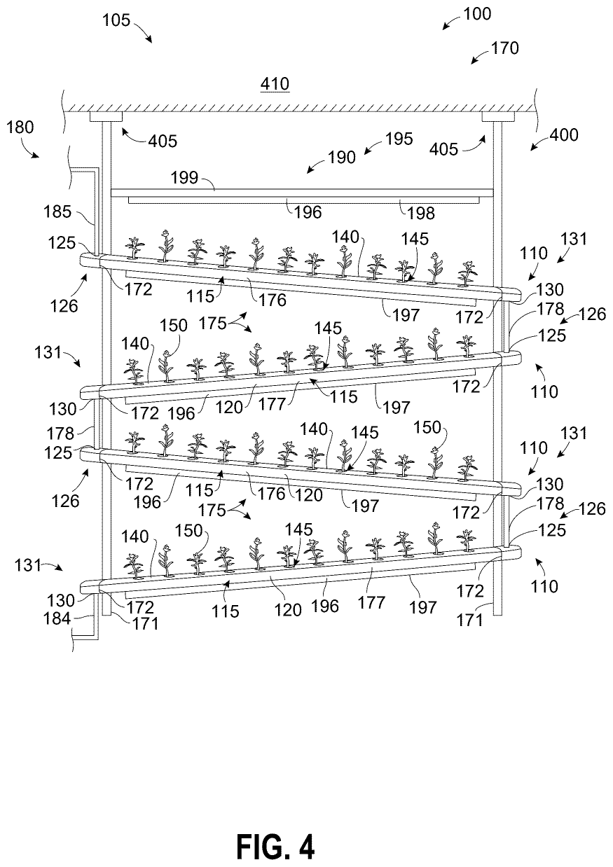

FIG. 4 shows another version of the hydroponics system 100 of the invention. In this version, the support structure 170 is a suspended support system 400 that hangs from a top support 405. The top support 405 can be any plate, bar, rod, or the like that is positioned above the support structure 170 and that is capable of supporting the weight of the support structure 170 and hydroponic stack 105. The top support 405 can be attached directly to a ceiling area 410 or can be attached to another structure that is positioned above the support structure 170. The suspended support system 400 offers advantages over a floor supported system, such as providing an uncluttered floor area which makes it easier for planting and harvesting, for storing equipment, and the like.

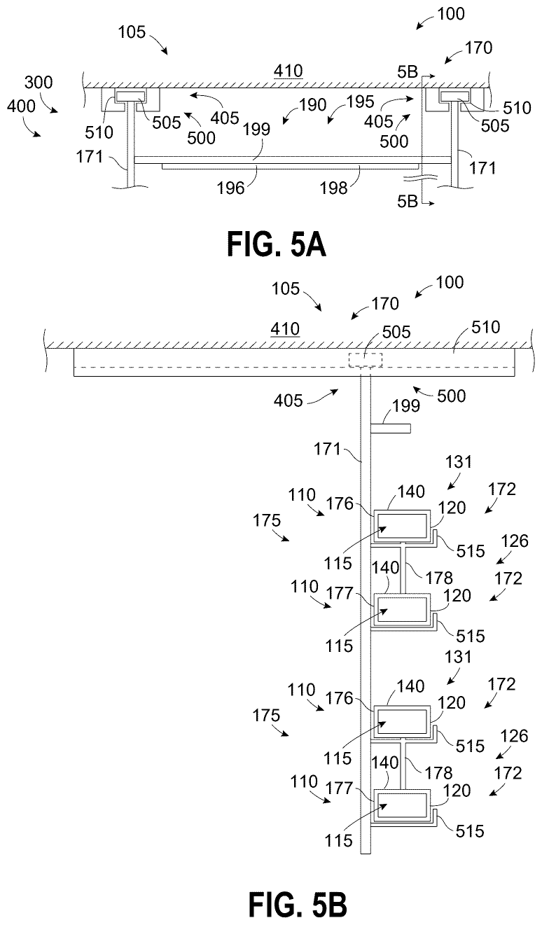

FIGS. 5A and 5B illustrate another version of the hydroponics system 100 of the invention. This version, the support structure 170 is both a moveable support structure 300 and a suspended support structure 400. The top support 405 comprises a moveable suspension mechanism 500 that allows the support structure 170 and a hydroponic stack 105 it supports to both hang and move in one or more directions. In the particular version shown, the top support 405 is a slidable member 505 that slides within a suspension channel 510 extending above the support structure 170. In the version of FIGS. 5A and 5B, the suspension channel 510 extends in a forward and backward direction relative to the hydroponic stack 105. The forward-backward direction is generally orthogonal to the longitudinal direction of the one or more hydroponic rows 110 in the hydroponic stack 105 and/or orthogonal to the general direction of an unslanted trough 115 from the first end 126 to the second end 131 and/or generally orthogonal to the direction of the flow of nutrient solution. Additional channels can be provided to allow the support structure 170 to move in one or more other directions alternatively or additionally. The support structure 170 can be moved by hand by an operator's applied force or a can move by a mechanical mechanism, as will be discussed. As also shown in the side view of FIG. 5B, the trough support members 172 in this particular version are in the form of hooks or platforms 515 that support the weight of the troughs 115.

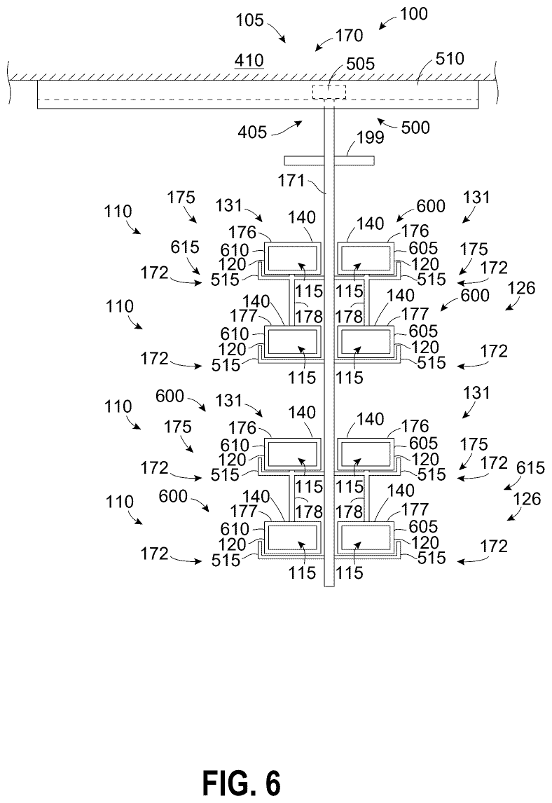

FIG. 6 shows another version of the hydroponics system 100 of the invention. The version of FIG. 6 is shown in the context of a version similar to the one of FIGS. 5A and 5B, but as with all features disclosed herein, is also applicable to any of the versions disclosed. In this version, the hydroponic stack 105 of the hydroponics system 100 includes a horizontal pair 600 of troughs 115 that are horizontally spaced from one another and/or horizontally aligned. The horizontal pair 600 of troughs 115 are made up of a forward trough 605 and a rearward trough 610. By horizontal is it meant that the forward trough and the rearward trough are offset from one another in a horizontal direction, i.e. in a direction orthogonal to the vertical direction. By horizontal it is not meant that the troughs necessarily lie in a horizontal plane, though they might. In the particular version shown the forward trough 605 and the rearward trough 610 are substantially parallel to one another and lie substantially in a plane slanted relative to a horizontal plane by the degree of slant of the troughs 115. The forward trough 605 may also be part of a vertically spaced pair 175 of troughs with another forward trough 605 positioned below. Likewise, the rearward trough 610 may also be part of a vertically spaced pair 175 of troughs with another rearward trough 610 positioned below. Accordingly, a set 615 of troughs may include a pair of vertically spaced pairs 175 and thus be made up of four troughs 115. In another version, the horizontal pair 600 may include a third intermediate trough positioned between the forward trough 605 and the rearward trough 610. In such version, the set would include six troughs 115. Similarly, two intermediate troughs can be provided to make a set 615 of eight troughs 115, etc. The horizontal pair 600 of troughs increases the plant growing capacity of a single hydroponic stack 105 contained on a single support structure 170.

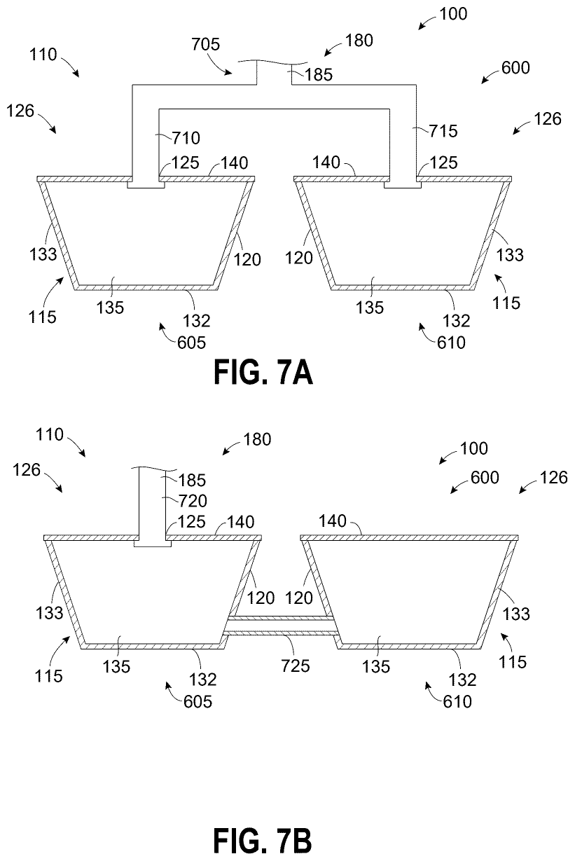

When a horizontal pair 600 of troughs 115 is provided in the hydroponics system 100, the circulation system 180 can provide nutrient solution to each trough separately through individual inlet lines 185 or a single inlet line 185 can be used to provide nutrient solution to both troughs of the horizontal pair 600. For example, as shown in FIG. 7A, the inlet line 185 can be a divided inlet line 705 that divides into a forward trough inlet line 710 and a rearward trough inlet line 715. Alternately, as shown in FIG. 7B, a single inlet line 720 version is illustrated. In this version, the inlet line 185 is a single inlet line 720 that provides nutrient solution to either the forward trough 605 or the rearward trough 610. The forward trough 605 and the rearward trough 610 then communicate the nutrient solution with one another. For example, as shown in FIG. 7B, one or more cross channels 725 can be provided so that nutrient solution in one of the troughs is also shared with the other trough.

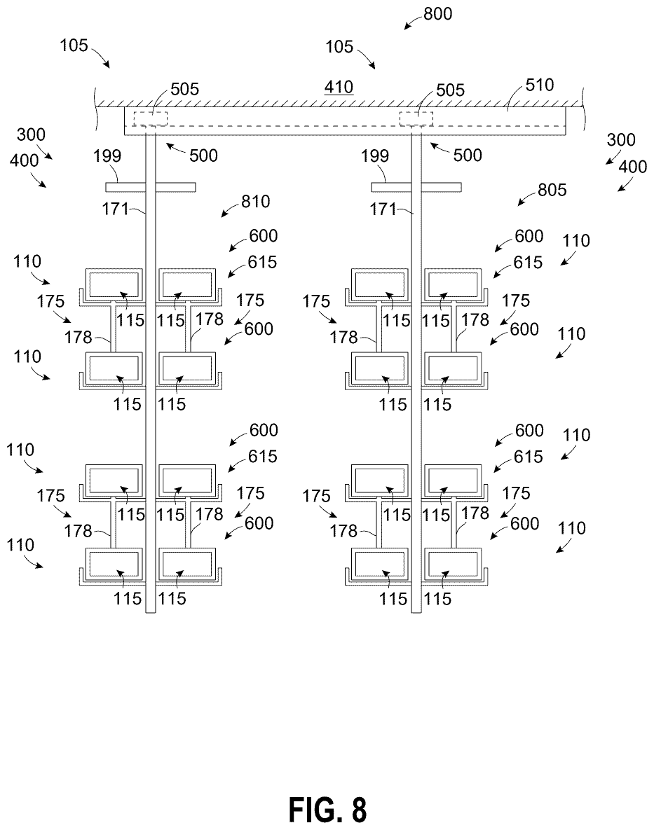

FIG. 8 shows another version of the hydroponics system 100 of the invention. In this version, the hydroponics system 100 is a multi-stack hydroponics system 800. The multi-stack hydroponics system 800 comprises a first hydroponic stack 805 and a second hydroponic stack 810. In the particular version of FIG. 8, the first hydroponic stack 805 and the second hydroponic stack 810 are both similar to the hydroponic stack 105 of FIG. 6. However, they can be similar to any version of the hydroponic stack disclosed and may each be the same or different from one another. In the version shown, each stack has a moveable support structure 300 so that the hydroponic stacks 105 can be moved for convenience purposes.

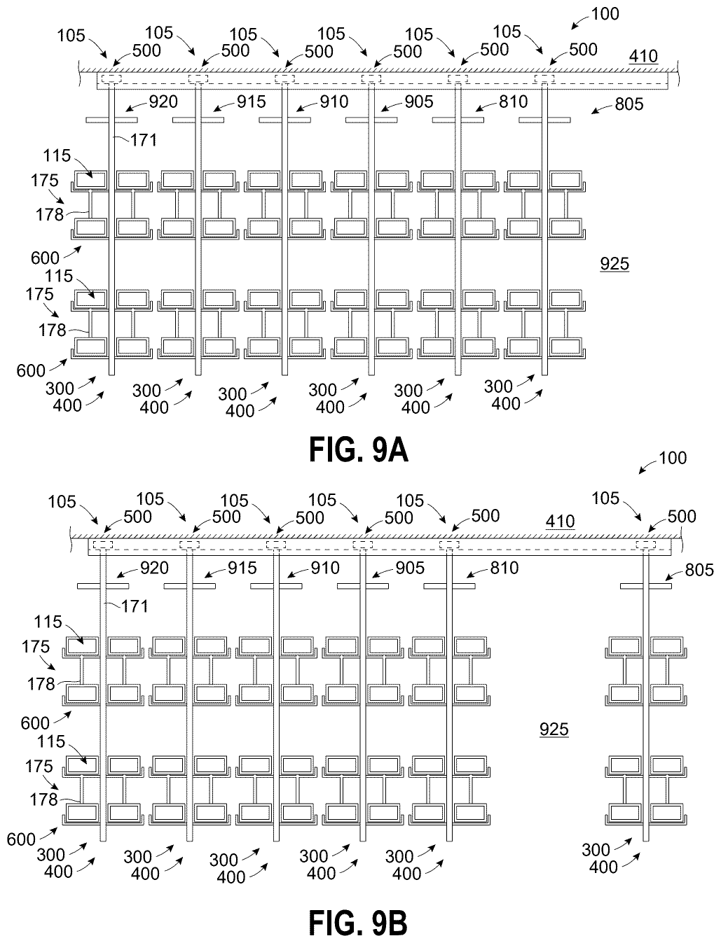

FIGS. 9A and 9B show a particular version of the multi-stack hydroponic system 800 of FIG. 8. In this version, several hydroponic stacks 105 are provided and are arranged in a space-maximizing or space-saving fashion. More specifically, as can be seen in FIG. 9A, the first hydroponic stack 805, the second hydroponic stack 810, and any additional hydroponic stacks 905, 910, 915, 920, etc. can be positioned adjacent or in close proximity to one another so that all of the available space is utilized by the stacks 105. An operational area 925 is provided next to one side of the first hydroponic stack 805 so that a user and/or equipment can access at least one side of the first hydroponic stack 805. To allow the second hydroponic stack 810 and/or the other side of the first hydroponic stack 805 to be accessed, the first hydroponic stack 805 can be moved to the position shown in FIG. 9B. In so doing, the operational area 925 is relocated to the space between the first hydroponic stack 805 and the second hydroponic stack 810. Access to the additional hydroponic stacks 905, etc. can be gained by subsequent movement of the stacks, as will be understood. The system of FIGS. 9A and 9B allows for the available space for the hydroponics system 100 to be maximized and/or best utilized with the entire available area minus the area needed for the operational area 925 to be filled with hydroponic stacks 105.

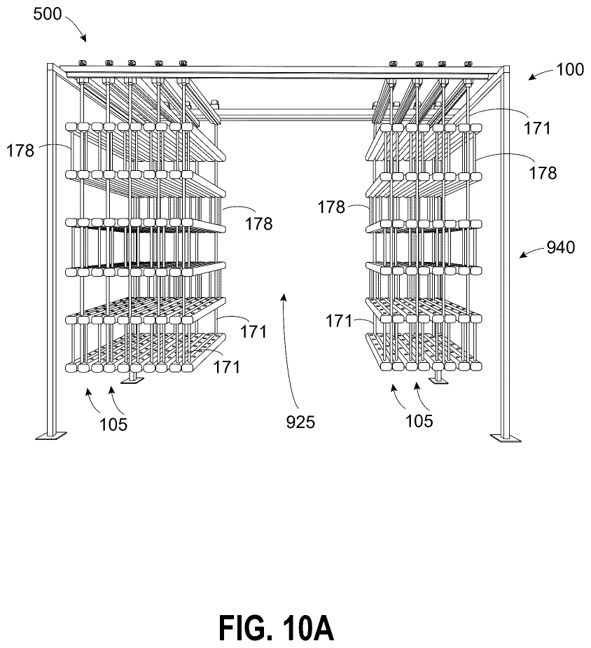

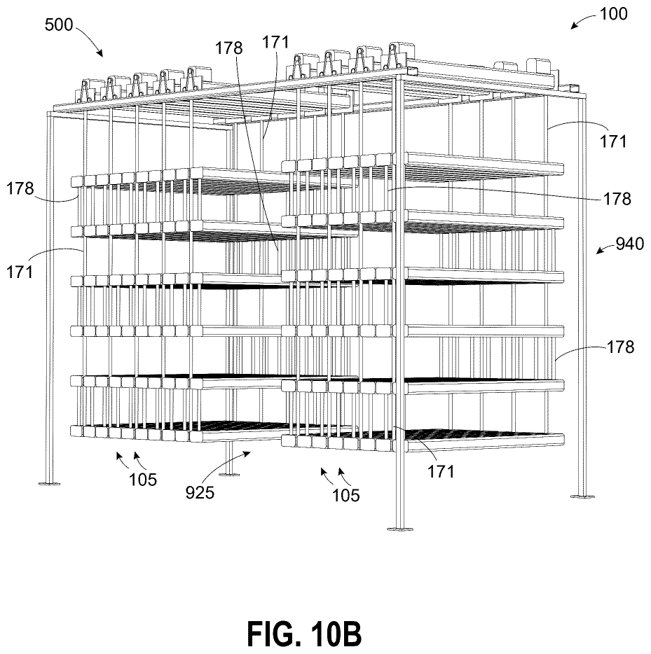

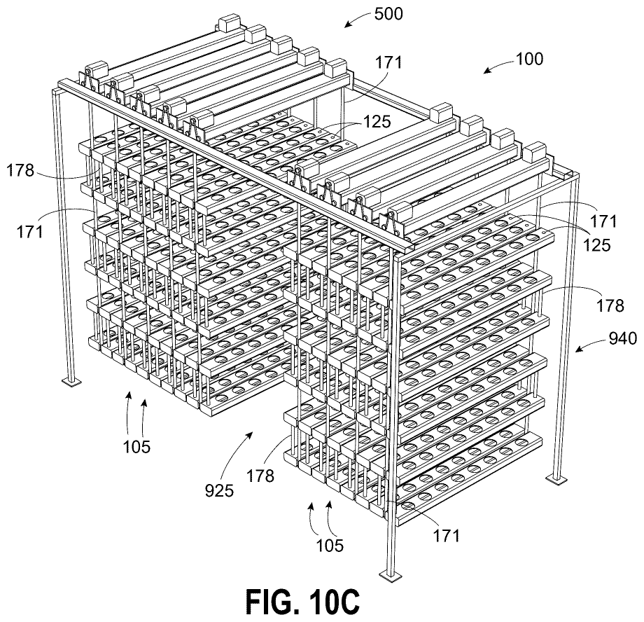

FIGS. 10A, 10B, and 10C show another version of a multi-stack hydroponic system 800 similar to the version of FIGS. 9A and 9B with an operational area 925 created between hydroponic stacks 105 by movement of the hydroponic stacks 105. As can be seen in FIGS. 10A, 10B, and 10CA a method of growing plants in a hydroponics system 100 comprises providing a plurality of hydroponic stacks 105, such as a first, second, and third hydroponic stack 105, and selectively creating the operational area 925 between selected ones of the plurality of hydroponic stacks 105. For example, the method can comprise moving the third hydroponic stack away from the second hydroponic stack to create an operational area 925 between the second hydroponic stack and the third hydroponic stack. Then the operational area 925 between the second hydroponic stack and the third hydroponic stack can be accessed by a human and/or a robotic unit to operate on the third hydroponic stack and/or the second hydroponic stack. The method can then comprise moving the second hydroponic stack toward the third hydroponic stack to reduce the operational area between the second hydroponic stack and the third hydroponic stack and to create an operational area 925 between the first hydroponic stack and the second hydroponic stack so that the operational area 925 between the first hydroponic stack and the second hydroponic stack can be accessed to operate on the second hydroponic stack and/or the first hydroponic stack. As also can be seen in FIGS. 10A, 10B, and 10C, the hydroponic stacks 105 are suspended from a frame 940, instead of from the ceiling.

The nutrient solution circulation system 180, not shown in FIGS. 10A, 10B, and 10C for clarity, delivers nutrient solution to the inlets 125 of the uppermost troughs 115, or to the highest trough 115 where plants are placed. The nutrient solution then flows through the troughs 115 and flow connectors 178, as discussed above. Either a separate reservoir 183 can be provided for each hydroponic stack 105 or one reservoir 183 can be used to provide nutrient solution to two or more hydroponic stacks 105.

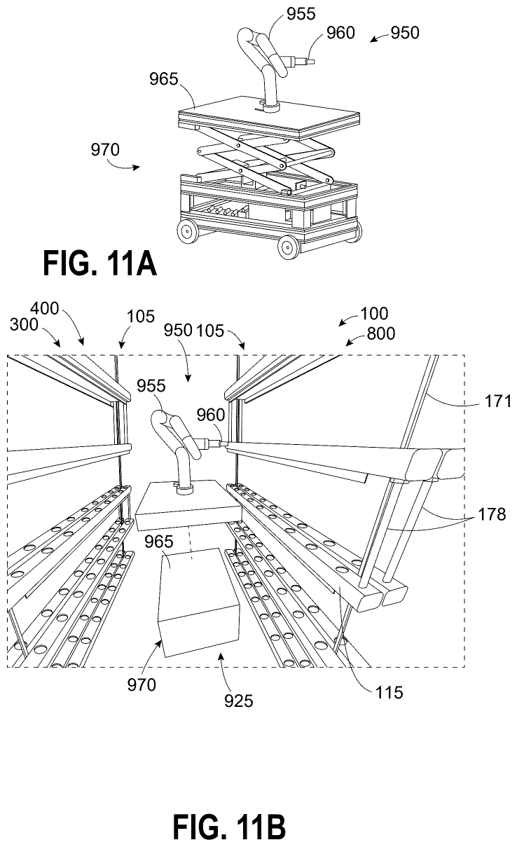

FIG. 11A shows a robotic system 950 that can be used in conjunction with any of the version of a hydroponics system 100 disclosed herein. In one version, the robotic system 950 comprises one or more robotic arms 955 having a plant container engaging member 960. The robotic arm is mounted on a platform 965. A movement system 970 can move the platform in multiple directions, such as the side-to-side and up-and-down movement shown. FIG. 11B shows the robotic system 950 in operation in an operational area 925 of a multi-stack hydroponics system 800. Operation of the robotic system 950 can be controlled by control system 200 or by a separate control system. The robotic system 950 can be used to manipulate the plants 150 and/or plant containers 155 into and out of the troughs 105, to harvest fruit bearing crops that are grown, to probe for data by either taking images or various scans to track the crop growth, and the like.

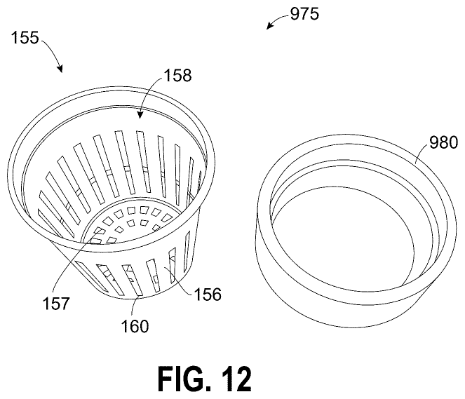

FIG. 12 shows a plant container pod system 975 that may be used in conjunction with the robotic system 950 of FIG. 11A. The plant container pod system 975 includes a lid adapter 980 positionable on a plant container 155. The lid adapter 980 is designed to be engageable by the plant container engaging member 960 on the robotic arm 955. The lid adapter 980 and other parts of the plant container pod system 975 can have any suitable size and shape, such as circular, round, square, rectangular, polygonal, or any combination thereof.

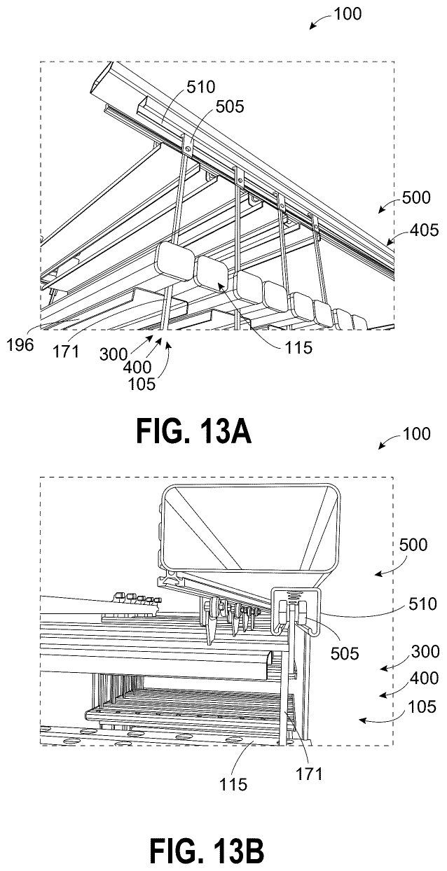

FIGS. 13A and 13B show a version of a moveable suspension mechanism 500 of the hydroponics system 100. FIGS. 13A and 13B show the moveable suspension mechanism 500 within a suspension channel 510 from a front view and from an isometric view without the front vertical legs obstructing the view.

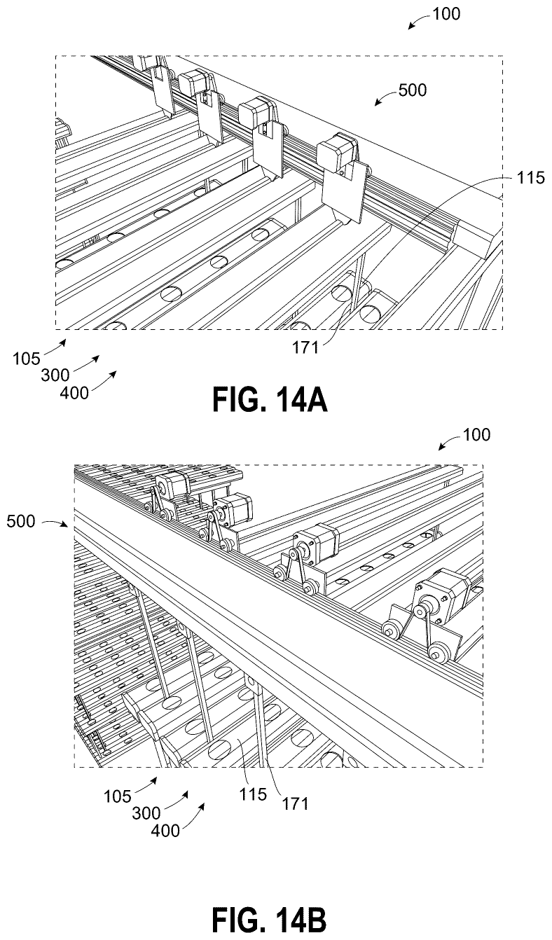

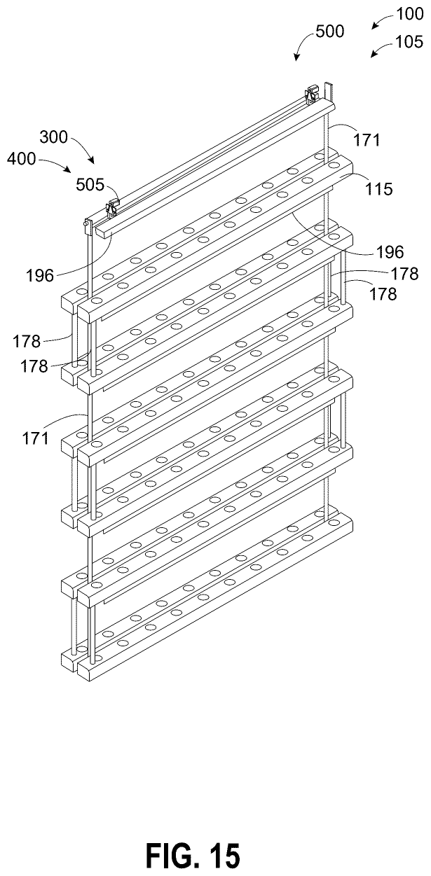

FIGS. 14A and 14B show a version of a moveable suspension mechanism 500 of the hydroponics system 100. The moveable suspension mechanism 500 of the version of FIGS. 14A and 14B is a rack and pinion system. FIGS. 14A and 14B show the rack and pinion or belt on a side channel, or it could be in the middle between two channels, from a front view and an isometric view without the front vertical legs obstructing the view. The rack and pinion or belt system moves the individual stacks via motors and an electronic system. FIG. 15 is a schematic front, side, top perspective view of a version of a hydroponic stack 105 of the hydroponic system 100 that can be used with the version of FIGS. 14A and 14B. In another version, a traveling bridge beam crane can be used to support and/or move the hydroponic stacks 105.

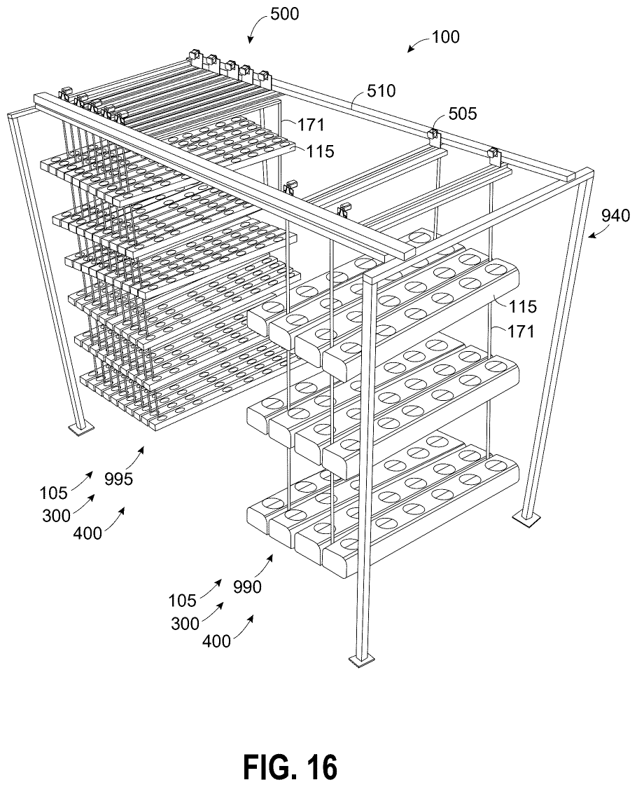

FIG. 16 shows another version of a hydroponics system 100 of the invention. In this version, a multi-stack system 800 includes stacks having troughs 105 with differing sizes, heights, and/or opening sizes. For example, in the version shown, one or more first troughs 990 have a first size, shape, or configuration and one or more second troughs 995 having a second size, shape, or configuration is provided. This allows the hydroponics system 100 to accommodate different plants or crops within the same system.

The hydroponics system 100 of the invention may be built in a fully enclosed building, a partially enclosed building, or outdoors. A fully enclosed or partially enclosed building may be provided with skylights, windows, etc, and can be designed to maintain temperature control and humidity levels. The hydroponics system 100 can have additional features that encourage plant growth and photosynthesis, such as by increasing the level of carbon dioxide exposed to the plants.

The hydroponics system 100 of the invention offers many advantages over conventional hydroponics systems. For example, the hydroponics system 100 of the invention can increase yield and efficiency in a given crop by having the ability to consolidate all the stacks when not in use. The system's only constraint will be the building it is constructed in. In addition, the building will prevent the crops from being susceptible to common pests and volatile weather. This would eliminate the need for pesticides/GMO crops and prevent the loss of crops. Overall, the system will increase yield due to the design that increases the density of crops and provides protection by the building enclosure. The system will also be more efficient due to the design that increases 0crop density and the ability to use of robotics with the system. In addition, the troughs can change size or shape without changing the underlying structure. The hydroponics system 100 can be built in any location that will allow and accommodate it. For example, the hydroponics system 100 can be located in densely populated areas that would otherwise not be able to support large scale agriculture. In such locations, fresh produce can be more easily provided to populations where it is otherwise difficult.

Although the present invention has been described in considerable detail with regard to certain preferred versions thereof, other versions are possible, and alterations, permutations and equivalents of the versions shown will become apparent to those skilled in the art upon a reading of the specification and study of the drawings. For example, the cooperating components may be reversed or provided in additional or fewer number, and all directional limitations, such as up and down and the like, can be switched, reversed, or changed as long as doing so is not prohibited by the language herein with regard to a particular version of the invention. Like numerals represent like parts from figure to figure. When the same reference number has been used in multiple figures, the discussion associated with that reference number in one figure is intended to be applicable to the additional figure(s) in which it is used, so long as doing so is not prohibited by explicit language with reference to one of the figures. Also, the various features of the versions herein can be combined in various ways to provide additional versions of the present invention. Furthermore, certain terminology has been used for the purposes of descriptive clarity, and not to limit the present invention. Throughout this specification and any claims appended hereto, unless the context makes it clear otherwise, the term “comprise” and its variations such as “comprises” and “comprising” should be understood to imply the inclusion of a stated element, limitation, or step but not the exclusion of any other elements, limitations, or steps. Throughout this specification and any claims appended hereto, unless the context makes it clear otherwise, the term “consisting of” and “consisting essentially of” should be understood to imply the inclusion of a stated element, limitation, or step and the exclusion of any other elements, limitations, or steps or the exclusion of any other essential elements, limitations, or steps, respectively. Throughout the specification, any discussion of a combination of elements, limitations, or steps should be understood to include (i) each element, limitation, or step of the combination alone, (ii) each element, limitation, or step of the combination with any one or more other element, limitation, or step of the combination, (iii) an inclusion of additional elements, limitations, or steps (i.e. the combination may comprise one or more additional elements, limitations, or steps), and/or (iv) an exclusion of additional elements, limitations, or steps or an exclusion of essential additional elements, limitations, or steps (i.e. the combination may consist of or consist essentially of the disclosed combination or parts of the combination). All numerical values, unless otherwise made clear in the disclosure or prosecution, include either the exact value or approximations in the vicinity of the stated numerical values, such as for example about +/−ten percent or as would be recognized by a person or ordinary skill in the art in the disclosed context. The same is true for the use of the terms such as about, substantially, and the like. Also, for any numerical ranges given, unless otherwise made clear in the disclosure, during prosecution, or by being explicitly set forth in a claim, the ranges include either the exact range or approximations in the vicinity of the values at one or both of the ends of the range. When multiple ranges are provided, the disclosed ranges are intended to include any combinations of ends of the ranges with one another and including zero and infinity as possible ends of the ranges. Therefore, any appended or later filed claims should not be limited to the description of the preferred versions contained herein and should include all such alterations, permutations, and equivalents as fall within the true spirit and scope of the present invention.

What is claimed is:

1. A hydroponics system comprising one or more hydroponic stacks, each hydroponic stack comprising:
a first trough, the first trough comprising a horizontally extending trough body, the trough body comprising walls that define an interior channel that extends from an inlet at an inlet end of the first trough to an outlet at an outlet end of the trough,
a second trough, the second trough comprising a horizontally extending trough body, the trough body comprising walls that define an interior channel that extends from an inlet at an inlet end of the first trough to an outlet at an outlet end of the trough,
a supporting structure that supports the first trough and the second trough, wherein the first trough and second trough are vertically spaced from one another and vertically aligned with one another, and
a flow connector that connects the outlet of the first trough to the inlet of the second trough,
wherein the first trough is adapted to contain a plurality of plants in an arrangement so that each plant in the first trough is in fluid communication with the interior channel of the first trough, wherein the second trough is adapted to contain a plurality of plants in an arrangement so that each plant in the second trough is in fluid communication with the interior channel of the second trough, and
wherein a nutrient solution can be introduced into the inlet of the first trough so that the nutrient solution can flow through the interior channel of the first trough to the outlet of the first trough, through the flow connector to the inlet of the second trough, and through the interior channel of the second trough to the outlet of the second trough.

2. A hydroponics system according to claim 1 wherein the first trough and the second trough make up a first pair of troughs of the hydroponic stack, wherein the hydroponic stack further comprises a second pair of first and second troughs, and wherein the second pair of troughs is vertically spaced and vertically aligned with the first pair of troughs.

3. A hydroponics system according to claim 1 wherein the first trough has a horizontally spaced trough pair and wherein the second trough has a horizontally spaced trough pair.

4. A hydroponics system according to claim 1 wherein the first trough has a horizontally spaced trough pair, and wherein the first trough and the horizontally spaced trough pair each have an inlet and an outlet.

5. A hydroponics system according to claim 1 wherein the first trough has a horizontally spaced trough pair, and wherein the first trough interior channel and the horizontally spaced trough interior channel are in direct flow communication with one another.

6. A hydroponics system according to claim 1 wherein the first trough and the second trough are rotated relative to one another about a vertical axis so that the inlet of the second trough aligns generally with the outlet of the first trough.

7. A hydroponics system according to claim 1 wherein the flow connector is a tube that connects the outlet of the first trough with the inlet of the second trough.

8. A hydroponics system according to claim 1 wherein a light is provided on a bottom of the first trough, the light being positioned to direct light onto one or more plants in the second trough interior channel.

9. A hydroponic system according to claim 1 wherein the first trough comprises a top member that at least partially covers the interior channel of the first trough, the top member having a plurality of openings, each adapted to receive a plant.

10. A hydroponics system according to claim 1 wherein the supporting system is suspended from a top support.

11. A hydroponics system according to claim 1 wherein the hydroponic stack is moveable so that supporting structure can be moved in a forward and backward direction, wherein the forward and backward direction is horizontal extension of the first trough and the second trough.

12. A hydroponics system comprising:
a first hydroponic stack, the first hydroponic stack comprising:
a plurality of horizontally extending and vertically spaced troughs, each trough comprising an interior channel adapted to contain a plurality of plants, and
a first supporting structure that supports the plurality of vertically spaced troughs of the first hydroponic stack; and
a second hydroponic stack, the second hydroponic stack comprising:
a plurality of horizontally extending and vertically spaced troughs, each trough comprising an interior channel adapted to contain a plurality of plants, and
a second supporting structure that supports the plurality of vertically spaced troughs of the second hydroponic stack,
wherein the second supporting structure is moveable relative to the first supporting structure so that the second hydronic stack can be moved towards or away from the first hydroponic stack, and
wherein a nutrient solution can flow through each of the interior channels to provide nutrients to the plants.

13. A hydroponics system according to claim 12 wherein the second supporting structure comprises one or more vertical support members.

14. A hydroponics system according to claim 12 wherein the second supporting structure comprises one or more vertical support members suspended from a top support.

15. A hydroponics system according to claim 12 wherein the second supporting structure comprises one or more vertical support members suspended from a top support, and wherein the top support comprises a moveable suspension mechanism that allows the second hydroponic stack to be moved sufficiently far away from the first hydroponic stack to create an operational area between the first hydroponic stack and the second hydroponic stack.

16. A hydroponics system according to claim 15 wherein the hydroponics system further comprises a robotic system that is selectively positionable within the operational area.

17. A hydroponics system according to claim 12 further comprising a third hydroponic stack, the third hydroponic stack comprising a plurality of horizontally extending and vertically spaced troughs, each trough comprising an interior channel adapted to contain a plurality of plants, and a third supporting structure that supports the plurality of vertically spaced troughs of the third hydroponic stack, and wherein the third supporting structure is moveable relative to the first supporting structure and the second supporting structure so that the third hydronic stack can be moved towards or away from the first hydroponic stack and the second hydroponic stack.

18. A hydroponics system according to claim 17 wherein the second supporting structure comprises one or more vertical support members suspended from a top support, wherein the third supporting structure comprises one or more vertical support members suspended from the top support, and wherein the top support comprises a moveable suspension mechanism that allows the second hydroponic stack to be moved sufficiently far away from the first hydroponic stack to create an operational area between the first hydroponic stack and the second hydroponic stack and allows the third hydroponic stack to be moved sufficiently far away from the second hydroponic stack to create an operational area between the second hydroponic stack and the third hydroponic stack.

19. A hydroponics system according to claim 12 wherein the hydroponics system comprises a lighting system adapted to provide light to the plants, wherein the lighting system comprises one or more lights connected to one or more of the troughs.

20. A method of growing plants in a hydroponics system, the method comprising:
providing a hydroponics system comprising a first hydroponic stack comprising a plurality of rows of plants; a second hydroponic stack comprising a plurality of rows of plants;
and a third hydroponic stack comprising a plurality of rows of plants;
moving the third hydroponic stack away from the second hydroponic stack to create an operational area between the second hydroponic stack and the third hydroponic stack;
accessing the operational area between the second hydroponic stack and the third hydroponic stack to operate on the third hydroponic stack and/or the second hydroponic stack;
moving the second hydroponic stack toward the third hydroponic stack to reduce the operational area between the second hydroponic stack and the third hydroponic stack and to create an operational area between the first hydroponic stack and the second hydroponic stack; and
accessing the operational area between the first hydroponic stack and the second hydroponic stack to operate on the second hydroponic stack and/or the first hydroponic stack.
